(19) United States
(12) Patent Application Publication
(10) Pub. No.: US 2003/0152696 A1
(43) Pub. Date: Aug. 14, 2003

(54) Method and apparatus for coating a web with a preferably dry treating agent

(76) Inventors: Vilho Nissinen, Numminen (FI); Risto Vaatanen, Helsinki (FI)

Correspondence Address: Michael C Stuart, Cohen Pontani Lieberman & Pavane, 551 Fifth Avenue Suite 1210, New York, NY, 10176, US

(21) Appl. No.: 10/311,408

(22) PCT Filed: Jun. 28, 2001
(86) PCT No.: PCT/FI01/00622

(30) Foreign Application Priority Data
Jun. 29, 2000 (FI) 20001548

(51) Int. Cl. B05D 3/08; B05D 3/12; B05D 3/02

(52) U.S. Cl. 427/223; 427/366; 427/385.5; 118/620; 118/641; 118/258

(57) ABSTRACT

A method and an assembly is disclosed for coating a web (1) of paper or board by a dry treatment agent, the method comprising the step of applying the treatment agent to at least one side of the moving web (1). In the method is used a treatment agent contains a binder capable of undergoing a change of state at least under the effect of elevated temperature. The web (1) after being treated with the treatment agent is subjected to at least an elevated temperature at which the binder becomes deformable, and the web is subjected to a lower temperature serving to set the binder so that the same bonds the treatment agent to the web surface. The solids content of the treatment agent is not less than 75%, preferably not less than 90%, whereby a drying step after the treatment is not required.

The invention relates to a method according to the preamble of claim 1 for coating the surface of a moving web of paper or board by a treatment agent which is adherable to the surface.

The invention also relates to an assembly for implementing the method.

The surface of a web of paper or board made from a fibrous stock is not optimal by its qualities for all applications. Most frequently, paper is used as a printing substrate. Different kinds of printing methods pose varying demands on the printing surface and the qualities of the printed end product are dictated by its targeted use. As an example of such varying demands, we may consider newsprint that must render a reasonably good printing quality in an advantageous way so that the overall cost of the paper and the printing method used for printing is minimized inasmuch the number of copies is large and the price of one copy may not rise high. Hence, newsprint is generally produced as uncoated or only lightweight coated grades. In contrast, a paper grade of entirely different qualities must be used when the goal is to achieve a high resolution and good color rendition in printing such products as pictorial books or high-quality periodicals. Herein, the paper must be selected from grades having a higher basis weight of the base sheet and a surface that is extremely smooth, glossy and white. These properties can be attained by coating the base web with several coat layers and subsequently smoothing the surface of the web by calendering.

Today, coating of paper and board webs takes place almost invariably using coating formulations prepared by mixing solids of suitable properties with water. The water-containing coating mix can be applied during production to the surface of a moving web by means of plural methods and, generally, the applied coat is smoothed by means of a doctor blade, rod or air knife. However, doctoring by an air knife is employed at slow web speeds only such as in the coating of cardboard webs, because the low doctoring efficiency of an air knife requires a sufficiently slow web speed to function. As coating mixes are applied to the web surface as a water-based slurry, the water carried over to the web by the coating mix must be removed by drying and the heavier the coat applied and the higher the web speed, the higher drying capacity is needed and the longer becomes the dryer section. Drying is also an energy-intensive process and the investment costs of a dryer section are high. In the preparation of a water-based coating mix, water is needed both for maling the coating mix and as a coating mix vehicle for transferring the coating mix along the applicator section, as well as for washing the equipment during maintenance. Although coating formulations do not contain hazardous substances, it is not allowable to pass washing waters and other process waters containing coating mix directly to the sewer, but instead such waters must be treated in a wastewater treatment plant, which means that the capacity of the treatment plant must be dimensioned so high as to cope with the treatment of coating mix wastewaters, too. Hence, notwithstanding the advances made in the preparation of water-based coating mixes in the art of papermaking, there appears to be an undeniable need for such surface treatment methods of paper and board webs that offer an essential reduction in the amount of water used or even a full freedom from the use of water as a carrier.

In addition to coating, webs of paper and board are treated by calendering, that is, by pressing and heating the web between two opposed surfaces. During this kind of treatment, the web inevitably undergoes compaction, that is, its density increases while its bulk is simultaneously reduced and the ratio of the web basis weight to the web stiffness decreases. To achieve a smooth web surface, the linear pressure of the calender nip must be increased and the nip temperature elevated, whereby these needs in combination with the trends toward higher web speeds and wider machines cause higher thermal and mechanical stresses that lead to expensive constructions and elevated risk of damage to rolls and other structures. Obviously the gloss and smoothness of paper grades must be improved in order to get glossy prints. On the other hand, calendering compromises web stiffness and opacity that is essential for a good printing result. Hence, the optimization of the different qualities of a printing paper is a vital and even a complicated task inasmuch improvements in certain qualities compromises others that also contribute to the printing result. Novel printing methods such as electronic printing pose such new requirements on the properties of a printing paper that cannot be met by present paper grades. While art printing papers have good surface qualities, they are incompatible with the feed systems and printing processes of electronic printers. On the other hand, presently available copier machine paper grades do not offer sufficiently high surface qualities for the most demanding printing jobs. Today, offset printing on sheets still gives a higher print quality than that of electronic four-color printers. Accordingly, there is a need to develop a method other than calendering that is suitable for glazing the surface of paper grades produced particularly for electronic four-color printers and, on the other hand, is capable of eliminating the loss of bulk in calendering or at least advantageously can reduce the degree of bulk reduction.

It is an object of the invention to provide a coating method for webs of paper or board using advantageously a dry treatment agent for application.

It is a further object of the invention to provide a glazing method for treating the surface of a product manufactured using the method according to the invention.

The goal of the invention is achieved by way of applying to the web to be treated a coating mixture comprising at least a pigment and a heat-formable binder and then adhering the mixture to the web surface at an elevated temperature.

According to a preferred embodiment of the invention, the web is subjected to pressure during the heating step to enhance the change of state in the binder.

The glazing method according to the invention is based on noncontacting heating of the web surface treated with the coating mixture so as to effect a change of state in the thermosetting polymer included in the coating formulation.

More specifically, the coating method according to the invention is characterized by what is stated in the characterizing part of claim 1.

Furthermore, the coater assembly according to the invention is characterized by what is stated in the characterizing part of claim 15.

The invention offers significant benefits.

The most important benefit of the invention is appreciated in the complete or at least substantially complete elimination of need for drying the web. Drying in needed only when water-containing coating mixtures are used or the coating is applied to a moist web. As the application of a dry coating to a moist base sheet makes it possible to form bonds between base sheet fibers and coating mix particles that improve the strength qualities of the coated surface, the presence of water in the base sheet or wetting of the same in certain cases may even be found advantageous. However, the base sheet water content must be sufficiently low not to jeopardize the adherence of the coating thereto during heating. As drying becomes unnecessary, the coating process is substantially simplified and the investment costs of the production line are reduced. Moreover, energy costs are reduced. The coating process is further streamlined by having no circulation and cleaning equipment for a water-containing coating mixture stock nor, as a rule, any kind of a separate leveling or smoothing step. Hence, the investment and operating costs of a coater line according to the invention are substantially lower than those of conventional lines. The environmental load imposed by the method is smaller than that of conventional methods, because no wastewater is generated and recycling of products is easier if coating is made using carbonate pigment. Lower environmental load is further accentuated by the reduced energy consumption of the method. As to engineering, the embodiment according to the invention can be implemented in plural different ways and lightweight equipment can be used, because the method needs no heavy pressing forces to be applied to the web nor a doctoring unit formed by a massive backing roll and doctor blade support beam. As the web moisture content remains unchanged, there is no need for the compensation of a longitudinal or lateral stretch of the web and, respectively, shrinkage at drying, whereby at least a number of spread rolls can be omitted and the tensile stress of the web becomes easier to control.

The coating method according to the invention offers an advantageous technique of rendering glaze finish to the web by way of heating its surface. As the base sheet is not subjected to mechanical pressing in this glazing method, no loss of bulk occurs.

In the following, the invention will be examined in greater detail with the help of exemplifying embodiments and making reference to the appended drawings in which

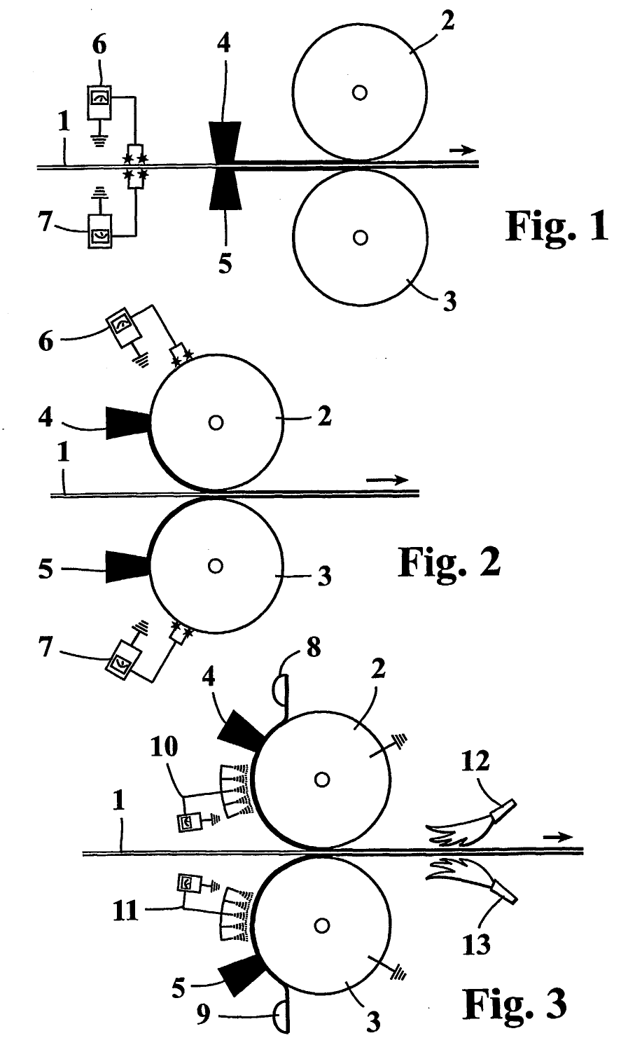

FIG. 1 shows a diagrammatic view of a first embodiment of the coating method according to the invention;

FIG. 2 shows a diagrammatic view of a second embodiment of the coating method according to the invention; and

FIG. 3 shows a diagrmmatic view of a third embodiment of the coating method according to the invention and a glazing method combined therewith.

In the text below, the term “change of state in the binder” is used when reference is made to the softening of the binder so that it can be brought into an at least partially flowable state by way of subjecting the binder to an elevated temperature and pressure. Then, the binder will settle about the pigment particles and pores of the base sheet, thus fixing the treatment agent to the web surface.

In the embodiment of the method shown in FIG. 1, a web 1 is adapted to pass through a nip formed between two heatable rolls 2, 3. Upstream from the rolls 2, 3 in regard to the travel direction of the web 1 are placed applicator devices 4, 5 suitable for distributing a pulverized treatment agent. The applicator devices 4, 5 are disposed on both sides of the web in the same fashion as the rolls and they extend in the cross-machine direction over the entire width of the web. Different applicator devices may be used. One alternative is to perform applications via a slit orifice formed to the wall of a suitable chamber, whereby the feed of the treatment agent is effected simply by the gravity of the treatment agent or by a positive feed pressure generated with the help of mechanical feeder means. Positive feed pressure is needed particularly in the case the applicator device is disposed below the web. However, as the travel direction of the web is not a limiting factor in the method according to the invention. The web may as well be arranged to travel upright or inclined from the upright, whereby there is no need to inject the treatment agent in the upright direction from the applicator slit. Coat weight control can be effected, e.g., by adjusting the gap width of the slit orifice or by altering the distance of the trailing edge of the slit from the web. In the latter case, the slit orifice facing the web can be made wider in the travel direction of the web, whereby a more uniform coat profile on the web can be attained. Another application method of the treatment agent is to use an array formed by a plurality of parallel and successive jet nozzles adapted for injection of a dry, pulverized treatment agent Herein, the number of nozzles must be sufficiently high to assure a uniform coverage by the applied treatment agent and the nozzles must be made from a material which is durable under the erosion of hard and abrasive pigment particles used in paper web coatings, such as kaolin and calcium carbonate.

An advantageous method of adhering a treatment agent such as a pulverized coating mix to the surface of a web is disclosed in the applicant's U.S. pat. appl. Ser. No. 09/508,943, based on international patent application PCT/FI98/00748. In the method described in this patent application, coating particles brought to a close vicinity of the web surface are adhered thereto by means of adapting to one side of the web a low-potential electrode, advantageously a ground electrode, while at least two pointed, high-potential electrodes are directed toward the first electrode on the opposite side. The high-voltage potential effects a corona discharge at the pointed electrode tips and, resultingly, the charged particles along with the ionized gas flow of the discharge are vigorously blasted toward the ground electrode. As the particles hit the web, they are effectively adhered thereto by the electric field. To use this method for application to a web of paper or board, the treatment agent must be introduced into the gap between the electrodes in a suitable manner. In addition to the application techniques mentioned above, this can be implemented using, e.g., a chamber wherein the treatment agent is introduced at a sufficiently high concentration. Herein, the pointed electrodes may be disposed in the interior of the chamber. The same arrangement may be utilized in the fashion described in the present patent application for controlling the spreading of dust in conjunction with other types of application methods. A more detailed description of the method is given in cited patent application appended to this application as references.

Upstream in front of the applicator devices 4, 5 are disposed corona discharge units 6, 7. With the help of these means, the web surface can be brought up to a suitably charged state, wherein improved adherence of the treatment agent applied to the web surface is attained. The function of this embodiment is based on charging the surface of the web 1 by means of the corona discharge units 6, 7 thus enhancing the adherence of the dry treatment agent applied to web surface. When the web is passed into the nip formed between the heatable rolls 2, 3, the heat of the rolls and the pressure in the nip softens the treatment agent binder at least so much that it becomes deformable, even more advantageously so as to take the binder above its melting point, whereby the binder penetrates into the pores between the web fibers and the pigment particles. At the exit of the web from the nip between the rolls 2, 3, the web surface cools off very rapidly and the binder bonds the pigment to the web surface. If necessary, the web surface can be cooled as may be needed when thick coats are applied, for instance. Cooling can be carried out using simple air-jet coolers.

In the embodiment of FIG. 2, the treatment agent is first applied to the periphery of heatable rolls 2, 3 by means of applicator devices 4, 5. In the rotation direction of the rolls, the applicator devices 4, 5 are preceded by corona discharge units 6, 7 facing the roll periphery so as to form thereon an electrical charge that adheres the treatment agent to the roll until the thus treated surface of the roll rotates into the nip between the rolls heatable 2, 3, wherein the treatment agent is transferred to the surface of the moving web 1. While this arrangement needs a smaller footprint in the travel direction of the web, it is necessary to select the surface material of the rolls 2, 3 so as to assure good adherence of the treatment agent thereto under the effect of the corona discharge. The treatment agent must contain a certain portion of a material capable of change of state in the nip between the heatable rolls. If the temperature of the rolls is set slightly lower than what is needed for the change of state, the pressure of the nip can be utilized to effect the change of state, whereby the treatment agent adheres easier to the porous surface of the web 1 rather than to smooth surfaces such as those of steel-shell rolls. In this respect, a metallic roll surface is preferred in the rolls inasmuch it may also be readily charged by a corona discharge.

In the embodiment of FIG. 3, the treatment agent is adhered to the rolls 2, 3 using an ion-blast apparatus 10, 11. Herein, the heatable rolls 2, 3 act as the ground electrodes, and the pointed ion-blast electrodes are disposed preceding the applicator devices of the treatment agent so that the electrodes are directed toward the roll surfaces. Spaced ahead of the applicator devices are disposed glue applicator units 8, 9. In this arrangement, the treatment agent is applied to the surfaces of the rolls 2, 3 in two steps. The first step comprises applying a glue that may be a suitable polymer or, e.g., a starch-based glue formulation. In this case, the glue maybe a water-based mixture that forms a film on the roll surface. The second step comprises applying a dry or almost dry pigment-containing component of the treatment agent that readily adheres to the moist glue film and the adherence of the treatment agent to the surfaces of the rolls 2, 3 is assured by means of the ion-blast apparatuses 10, 11. This arrangement leaves the glue component serving to adhere the treatment agent as the uppermost layer of the applied coating, whereupon it penetrates in the nip partially through the pigment-containing component of the treatment agent thus fixing the pigment to the web. The assembly shown in this diagram may be modified so that, e.g., the glue or the pigment-containing component of the treatment agent is applied directly to the web as shown in FIG. 1, for instance, while the other component of the treatment agent is applied to the roll surfaces. Obviously, in lieu of a moist glue formulation it is possible to use a dry fixing agent that melts in the nips of the heatable rolls. The latter arrangement brings about the benefit of easier control of the final coating layer by way of making modifications in the compositions of the separately applied components of the treatment agent as compared to the use of a single-component treatment agent only, whose modification needs replacing the entire amount of treatment agent loaded into the system and mixing a new formulation with the desired properties.

In the assembly shown in FIG. 3, the roll nip is followed by flame-glazing devices 12, 13. These may be gas torches, hot-air jets, infrared heaters or the like, by means of which the web surface can be heated to a sufficiently high temperature at which the meltable components of the treatment agent soften. The flame-glazing method is described later in more detail.

In the method according to the invention, the adherence of the pigment-containing treatment agent to the surface of the web 1 is effected in a roll nip similar to a calender nip. Herein, the treatment agent must have a formulation comprising at least one pigment component and at least one binder component. The binder is a heat-meltable material, advantageously some polymer such as a polyester resin, copolymer of styrene and butadiene or the like material that can be deformed by heat and pressure so that it, after curing, binds the pigment particles to each other and to the surface of the web being treated. Generally suitable for use as the binder are natural resins and semisynthetic or fully synthetic resins, as well as polymers of the thermoplastic and thermosetting moiety. The pigments may obviously be those conventionally used in papermaking such as calcium carbonate and kaolin in its various forms and titanium oxide, for instance. Typically, a white surface is desired as this kind of surface is most suitable for printing, but the invention may as well be used for making a colored surface by way of maling the treatment agent using a dye that renders the desired color. The solids content of the treatment agent should be not less than 75%, preferably not less than 90%, whereby a drying step after the treatment is not required.

If the coating method according to the invention is carried out using at least one thermoplastic polymer as the binder, the web surface can be advantageously glazed by heating the surface to the melting point of the polymer or even higher than the melting point. While in the context of the present patent application this glazing method is called flame glazing, the heating step may as well be performed using a hot-air jet or radiant heater. However, flame heating is advantageous by way of offering a high heating temperature, whereby the heating time is short and cooling takes place rapidly. Due to these reasons, flame heating gives a better surface quality. It is an essential feature of the invention that glazing is made in a noncontacting manner and for a dry web thus causing no change in the web thickness or bulk

Heating was tested by treating paper sheets with black and colored photocopier toner. With the black toner and using a hot-air jet, the increase of glaze was 10 to 30% on the Hunter scale. In a color print, the glaze improvement on the Hunter scale was 32 to 70% and simultaneously the surface smoothness according to PPS S10 improved from 4.2 μm to 3.8 μm. Stripes on the photocopy disappeared. It was further noted that the glaze of the darker areas increased by the greatest amount. This is a desirable feature in comparison with current printing techniques inasmuch also they produce a higher glaze at the darker areas.

The above-described flame-glazing method is particularly suited for use in conjunction with paper or board webs manufactured by the method according to the invention, because the printing surface already contains a polymer that can be glazed. Advantageously, the method may also be applied so that the glazing step is performed later at the printer, whereby the papermaking machine is used for producing unglazed paper, and the paper is glazed by heating in a noncontacting manner either prior to printing or after printing. If glazing is carried out after printing, the printing surface need not necessarily contain a polymer provided that the polymer binder can be incorporated into the printing ink Obviously, this approach produces glaze finish only on the printed areas. The temperature of the heating medium or flame may be 50 to 4000° C., typically 300 to 1500° C., and the surface temperature for heat-treating the web is selected according to the melting point of the polymer to be glazed by a heat-treatment The flame or the hot gas jet can be produced by means of a burning flame of a gas or a gas mixture or, alternatively, the gas may be heated by some other medium.

Without departing from the spirit and scope of the invention, also embodiments different from those described above may be contemplated. The coating method according to the invention can be used for treating an uncoated web of board or paper or the invention may be employed for applying one or more coating layers in multilayer coating or in conjunction with other coating methods. Obviously, coating may also be applied in two different steps on either side of the web or the web may be coated only one-sidedly. While the binder may be included in the treatment agent mixture as separate particles, the use of a pigment precoated with the binder assures a uniform distribution of the binder in the coating. A belt can be used in lieu of a roll either for transferring the treatment agent to the web surface or heating a treated web surface. It may even be contemplated that the web surface is treated only by noncontacting heating, whereby the pigment is adhered to the web surface by the melting binder alone.

What is claimed is:

1. Method for coating a web (1) of paper or board by a dry treatment agent, the method comprising the step of
applying the treatment agent to at least one side of the moving web (1), characterized in that
using a treatment agent containing a binder capable of undergoing a change of state at least under the effect of elevated temperature,
subjecting the web (1) after being treated with the treatment agent to at least such an elevated temperature at which the binder becomes deformable, and
bringing the web to a lower temperature serving to set the binder so that the same bonds the treatment agent to the web surface.

2. Method according to claim 1, characterized in that the solids content of the treatment agent is not lower that 75%, advantageously not lower than 90%.

3. Method according to claim 1, characterized in that the treatment agent is applied directly to the surface of the web (1) and the web surface is subjected to a corona discharge prior to the application of the treatment agent.

4. Method according to claim 1, characterized in that the treatment agent applied to the surface of the web (1) is heated and pressed by means of at least one heatable roll (2, 3).

5. Method according to claim 4, characterized in that the treatment agent is first applied to the surface of the roll (2, 3) and is then transferred on the surface of the moving roll (2, 3) to the surface of the web (1) and that the treatment agent is subjected to said elevated temperature by heating the roll (2, 3) on which the treatment agent is being transferred.

6. Method according to claim 1, characterized in that the treatment agent is applied directly to the surface of the roll (2, 3) and the roll surface is subjected to a corona discharge prior to the application of the treatment agent.

7. Method according to claim 5, characterized in that the treatment agent is applied to the surface of the roll (2, 3) and the roll surface is subjected to a corona discharge prior to the application of the treatment agent.

8. Method according to claim 5, characterized in that the treatment agent is first applied to the surface of the roll (2, 3) and, in a location situated between the application point of the treatment agent and the meeting point of the web with the roll surface, there is adapted at least one pointed electrode with its tip directed toward the roll surface and a voltage difference is connected between said electrode and the roll.

9. Method according to claim 5, characterized in that the treatment agent is applied directly to the surface of the web (1) and, in a location situated downstream on the web travel after the application point of the treatment agent, there is disposed at least one pointed electrode with its tip directed toward the web surface and there is disposed a counterelectrode on the opposite side of the web in relation to the pointed electrode and a voltage difference is connected between said electrodes.

10. Method according to any one of foregoing claims as used for glazing a web of paper or board treated with a heat-deformable binder such as a polymer or resin, characterized in that the surface of the paper or board web is heated to a temperature at least so high as to cause a change of state in the binder incorporated in the paper or board.

11. Method according to claim 10, characterized in that the web surface is heated to a temperature so high as to cause at least a partial melting of the binder.

12. Method according to claim 10, characterized in that the surface of the web of paper or board is heated by means of a flame, a radiant heater or a jet of hot gas.

13. Method according to claim 12, characterized in that the temperature of the flame, radiant heater or jet of hot gas is 50 to 4000° C., advantageously 300 to 1500° C.

14. Method according to claim 10, characterized in that a noncontacting technique is used for heating a surface produced by a printer or copier device.

15. Assembly for coating a web (1) of paper or board with a dry coating-type treatment agent, the assembly comprising means (4, 5) for applying the treatment agent to at least one surface of the moving web (1), characterized by means (2, 3 or 12, 13) for heating the web surface so as to cause a change of state in the binder contained in the treatment agent.

16. Assembly according to claim 15, characterized by means (4, 5) for applying a treatment agent directly to the surface of the web (1) and by at least one corona-discharge device (6, 7) for subjecting the web surface to a corona discharge prior to the application of the treatment agent.

17. Assembly according to claim 15, characterized by at least one heatable roll (2, 3) for heating and pressing the treatment agent applied to the surface of the web (1).

18. Assembly according to claim 17, characterized by means for applying the treatment agent to the surface of at least one roll (2, 3) on which surface of the roll (2, 3) the treatment agent can be transferred to the surface of the web (1) and the treatment agent can be heated by way of heating the roll (2, 3) carrying the treatment agent.

19. Assembly according to claim 15, characterized by means (4, 5) for applying the treatment agent to the surface of at least one roll (2, 3) and means (6, 7) for subjecting the roll surface to a corona discharge prior to the application of the treatment agent.

20. Assembly according to claim 15, characterized by means (4, 5) for first applying the treatment agent to the surface of the roll (2, 3) and followed by at least one pointed electrode which has its tip directed toward the roll surface and is disposed between the application point of the treatment agent and the meeting point of the web with the roll surface and further has a voltage difference connected between the electrode and the roll.

21. Assembly according to claim 15, characterized by means for applying the treatment agent directly to the surface of the web (1) and by at least one pointed electrode that has its tip directed toward the web surface and is disposed in a location situated downstream on the web travel after the application point of the treatment agent and by a counterelectrode disposed on the opposite side of the web in relation to the pointed electrode, said electrodes having a voltage difference connected therebetween.

22. Assembly according to any one of foregoing claims 15-21 as used for glazing a web of paper or board containing a heat-deformable binder such as a polymer or resin, characterized by a heater (12, 13) for heating the surface of the web of paper or board to a temperature at least so high as to cause a change of state in the binder incorporated in the paper or board.

23. Assembly according to claim 22, characterized in that the means for heating the surface of the web of paper or board is a flame torch, a radiant heater or a jet of hot gas.

24. Assembly according to claim 22, characterized in that the temperature of the flame torch, radiant heater or jet of hot gas is 50 to 4000° C., advantageously 300 to 1500° C.

25. Method according to claim 23, characterized in that said heater is adapted to operate in conjunction with a printer or copier device so as to heat in a noncontacting manner a surface processed in said device.
